(19) United States
(12) Patent Application Publication
(10) Pub. No.: US 2022/0134393 A1
(43) Pub. Date: May 5, 2022

(54) Methods and Systems for Automated Cleaning of Immersion Tanks

(71) Applicant: Morris & Associates, Inc., Garner, NC (US)

(72) Inventors: Christopher Gorni, Cary, NC (US); Derek William Thompson, Knightdale, NC (US); John P. Shell, Raleigh, NC (US)

(21) Appl. No.: 17/427,270

(22) PCT Filed: Feb. 7, 2020
(86) PCT No.: PCT/US2020/017186

§ 371 Date: Jul. 30, 2021

Related U.S. Application Data
(60) Provisional application No. 62/802,863, filed on Feb. 8, 2019.

(51) Int. Cl. B08B 9/08; B08B 3/08

(52) U.S. Cl. CPC B08B 9/0804; B08B 3/08

(57) ABSTRACT

A method for automated cleaning of an immersion tank (14) includes: substantially enclosing an interior volume (30) of the immersion tank (14); increasing the temperature and humidity in the interior volume (30) of the immersion tank (14); then applying cleaning solution to interior surfaces of the immersion tank (14); and rinsing the cleaning solution and soil off the interior surfaces of the immersion tank (14).

### RELATED APPLICATIONS

This application claims priority from U.S. Provisional Application No. 62/802,863, filed Feb. 8, 2019, the disclosure of which is hereby incorporated by reference herein in its entirety.

### BACKGROUND

Various food processing operations employ large tanks in which edible products are deposited at an inlet end of the tank, immersed in a fluid in the tank, mechanically transported along the length of the tank and removed from the tank at an outlet end. While immersed in the fluid, the product may be chilled, thawed, cooked, cured or otherwise altered according to the purpose of the processing operation. Products may range from freshly slaughtered poultry to cooked ham to frozen meat to soy protein to bagged beans or numerous other food products. In the course of processing the product, fats, grease, bits of product or other materials may contaminate the fluid in the tank and be deposited on mechanical surfaces of the tank or within the tank. These surfaces must be periodically cleaned to avoid culturing microbes that could contaminate the product.

In particular, the poultry processing industry employs poultry chillers to remove body heat from the animal product shortly after evisceration. Poultry chillers employ various mechanisms for chilling the product including immersion in cold water and/or exposure to cold air. The volume of poultry processed in modern facilities dictates that these chillers are physically large. Immersion type chillers are commonly 8 to 12 feet in diameter and over 60 feet in length.

In immersion type chillers, as product is immersed in cold water, some fat, oil, blood, residual feathers and/or other matter may dislodge from the product and be deposited onto mechanical surfaces within the tank. Such surfaces include but are not limited to the inner surface of the tank and the surfaces of motive components such as an auger, dasher or paddles that move product inside the tank. The chillers must be cleaned periodically to prevent contamination of poultry product with harmful pathogens. Cleaning is typically done daily, but in some cases less frequently where additional sanitation steps are employed.

Cleaning has historically been a manual process. Most immersion chillers have a large upper opening that is accessible from elevated catwalks along the sides of the chiller. In situations where this opening is covered, cleaning workers open the covers to provide access to the interior of the chiller. Workers then power-wash the interior of the chiller with hot water to remove most of the visible soil. Because the top of the chiller is open, air inside the chiller that is heated and humidified by the spray quickly rises up through the open top of the chiller and disperses throughout the room in which the chillers are located. Cooler dry air from the room falls down through the opening into the chiller. After the initial washing, workers apply chemical foam onto the equipment to break down the remaining soil film. Finally, they rinse the chiller off with high pressure spray wands. This process is time consuming, unpleasant for the workers and consumes large quantities of hot water.

It would be desirable to automate the cleaning process, but replication of the manual process using a limited number of fixed spray stations has proven challenging. Where it has been attempted, cleaning efficacy has been low due in part to the difficulty of reaching all the surfaces with a direct spray from a limited number of fixed points. An additional challenge arises due to the relatively long distance from fixed nozzles outside the chiller to certain places inside the chiller. Water that leaves such a nozzle at a relatively high temperature can cool due to evaporation before it impinges the far wall. The water may no longer be warm enough to melt or soften fat deposited on the wall. Furthermore, velocity of the spray is reduced by drag interactions with air. To improve efficacy, higher quantities of water have been applied over longer periods of exposure, but this approach incurs unacceptable water consumption or operating expense.

When the chillers are cleaned manually, workers can reach inside the chiller with their spray wands to get closer to soiled surfaces, but this creates safety hazards, since the motive mechanisms inside the chiller are often rotating or otherwise moving to provide exposure for all soiled surfaces. In an automated process, provisions to extend spray nozzles into the chiller require complicated mechanisms that increase the equipment cost and maintenance cost of the system.

The current invention overcomes the limitations of automated cleaning by adding a process step in which the chiller is filled with hot, humid air for a period of time. The present inventors discovered this phenomenon as they were attempting to develop an automated high-pressure spray system, and spread a tarp over the chiller to reduce fugitive spray splashing outside the chiller. The resulting hot and humid conditions soften or melt any fats that may have congealed on the chiller surfaces making it possible to remove contaminants from these surfaces quickly with relatively low velocity water sprays. It becomes possible to create conditions within the enclosed chiller that are too hostile for worker exposure. Chillers treated with such aggressive heat and humidity soften the fats to the extent they can be effectively cleaned even where water sprays do not directly impinge the entire inner surface of the chiller but reach certain portions of the chiller surface only by indirect splashing. The present invention can reduce water consumption, labor costs and cleaning time.

### SUMMARY

Some embodiments of the present invention are directed to a method for automated cleaning of an immersion tank. The method includes: substantially enclosing an interior volume of the immersion tank; increasing the temperature and humidity in the interior volume of the immersion tank (e.g., for a predetermined amount of time); then applying cleaning solution to interior surfaces of the immersion tank; and rinsing the cleaning solution and soil off the interior surfaces of the immersion tank.

In some embodiments, substantially enclosing an interior volume of the immersion tank includes closing hoods and/or covers over an upper opening of the immersion tank.

In some embodiments, increasing the temperature and humidity in the interior volume of the immersion tank includes spraying hot water through nozzles into the interior volume of the immersion tank.

Applying cleaning solution to interior surfaces of the immersion tank may include dispersing the cleaning solution through the nozzles onto the interior surfaces of the immersion tank. The nozzles may be arranged such that cleaning solution is applied to substantially all of the interior surfaces of the immersion tank.

Rinsing the cleaning solution and soil off the interior surfaces of the immersion tank may include spraying water through the nozzles onto the interior surfaces of the immersion tank. The immersion tank may include an auger oriented in a longitudinal direction in the interior volume of the immersion tank. Adjacent ones of the nozzles may be spaced apart in the longitudinal direction a lesser distance than a pitch of the auger.

In some embodiments, the temperature and humidity are increased in each portion of the interior volume of the immersion tank for at least two minutes before the cleaning solution is applied to interior surfaces of the immersion tank.

In some embodiments, the method further includes draining the cleaning solution and soil from the interior volume of the immersion tank.

In some embodiments, the immersion tank is a poultry chiller.

Some other embodiments of the present invention are directed to a system for automated cleaning of an immersion tank. The system includes: an immersion tank including a tank defining an interior volume and an upper opening in communication with the interior volume; a plurality of hoods and/or covers configured to selectively cover the upper opening to substantially enclose the interior volume; and at least one nozzle configured to: spray hot water into the interior volume to increase the temperature and humidity in the interior volume; disperse cleaning solution onto interior surfaces of the immersion tank; and spray water onto the interior surfaces of the immersion tank to remove the cleaning solution and soil therefrom.

In some embodiments, the at least one nozzle includes a plurality of nozzle clusters distributed axially along the tank, each nozzle cluster including a plurality of nozzles.

In some embodiments, each nozzle cluster includes: a primary pipe with an inlet; a first secondary pipe extending laterally away from a first side of the primary pipe; a second secondary pipe extending laterally away from a second, opposite side of the primary pipe; a first nozzle at the end of the first secondary pipe and a second nozzle at the end of the second secondary pipe. The nozzle cluster may be positioned such that the first nozzle is adjacent a first side of the upper opening and the second nozzle is adjacent a second, opposite side of the upper opening.

The first and second nozzles may each include dispersion characteristics that provide substantially 360-degree coverage from the location of the nozzle.

In some embodiments, each nozzle cluster includes: a third secondary pipe extending laterally away from the second side of the primary pipe and spaced apart from the second secondary pipe; a third nozzle at the end of the third secondary pipe. A first nozzle cluster may be positioned such that the first nozzle is adjacent the first side of the upper opening and the second and third nozzles are adjacent the second side of the upper opening and a second nozzle cluster adjacent the first nozzle cluster may be positioned such that the first nozzle is adjacent the second side of the upper opening and the second and third nozzles are adjacent the first side of the upper opening.

In some embodiments, the first and second secondary pipes each extend outwardly and downwardly from the primary pipe such that an obtuse angle is defined between each of the first and second secondary pipes and the primary pipe and/or substantially all liquid in the pipes drain out through the nozzles when the supply of liquid is stopped.

In some embodiments, the system further includes: a hot water header in fluid communication with the inlet of the primary pipe; a first control valve between the hot water header and the inlet of the primary pipe to selectively supply hot water to the nozzle cluster; a cleaning solution header in fluid communication with the inlet of the primary pipe; and a second control valve between the cleaning solution header and the inlet of the primary pipe to selectively supply cleaning solution to the nozzle cluster.

In some embodiments, the system further includes a rail below the one or more hoods and/or covers and a carriage connected to the rail with the at least one nozzle connected to the carriage. The carriage and the nozzle may be configured to travel on the rail axially along the tank to sequentially spray hot water and cleaning solution at different axial locations along the tank.

In some embodiments, the at least one nozzle is held within an at least partially spherical nozzle mount that is held in a socket. The nozzle mount may be rotatable and/or translatable in the socket such that the nozzle is articulated to sequentially direct the water and/or cleaning solution to different interior surfaces in the interior volume of the tank.

In some embodiments, the immersion tank is a poultry chiller.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a perspective view of a chiller according to some embodiments of the present invention.

FIG. 2 is a side view of the chiller of FIG. 1 with portions of a side wall removed.

FIG. 3 is an end view of the chiller of FIG. 1.

FIG. 4 is a section view of the chiller of FIG. 1.

FIG. 5 is a top view of the chiller of FIG. 1.

FIG. 6 is a top view of nozzle clusters and piping that may be used with the chiller of FIG. 1.

FIG. 7 is a perspective view of the nozzle clusters and piping of FIG. 6.

FIG. 8 is a side view of the nozzle clusters and piping of FIG. 6.

FIG. 9 is an end view of the nozzle clusters and piping of FIG. 6.

FIG. 10A is a side perspective view of a ball-and-socket nozzle assembly.

FIG. 10B is another (opposite side) perspective view of the ball-and-socket nozzle assembly of FIG. 10A.

FIG. 11A is a side perspective view of a yoke and nozzle mount assembly of the ball-and-socket nozzle assembly of FIGS. 10A and 10B.

FIG. 11B is another (opposite side) perspective view of the yoke and nozzle mount assembly of FIG. 11A

FIG. 12 is a perspective view illustrating a plurality of the ball-and-socket nozzle assemblies of FIGS. 10A and 10B linked together.

FIG. 13 is a side view of a traveling nozzle cluster.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “includes,” “comprising,” and/or “including,” when used in this specification, specify the presence of stated features, integers, steps, operations, elements, and/or components, but do not preclude the presence or addition of one or more other features, integers, steps, operations, elements, components, and/or groups thereof.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “nozzle” means a device for introducing liquid into the tank in a manner that causes the liquid to spread across an intended portion of interior surfaces in the tank.

The present invention addresses cleaning and sanitizing immersion tanks for food processing applications and in particular, poultry chilling. The invention may be applied to a variety of types of immersion tanks including poultry chillers. Chillers may be broadly categorized as immersion chillers in which the product is immersed in cold water, air chillers in which cold air is circulated around the product and other types of chillers in which heat is removed from the product by means such as evaporation or radiation. This discussion focuses on immersion chillers, since outside of Europe they are the most commonly used. However, the principles disclosed can readily be applied to other types of immersion tanks by those of ordinary skill in the art.

Even within the category of immersion chilling, a number of configurations are employed. Most common in recent years are so-called auger chillers in which product is advanced through a tank of water by rotation of an auger and rocker chillers in which product is kept suspended in water contained in a tank by the motion of a dasher oscillating within the tank. So-called drag chillers are still produced in which the product is advanced along the length of a tank by paddles extending down into the water which are caused to move from one end of the tank toward the other by mechanical means. All are suitable applications for the current invention.

The present invention works by creating conditions of temperature and humidity adjacent soiled surfaces that softens accumulated fat making it easier to remove from the surface. In some cases, the fat may melt entirely. Relatively low velocity streams or jets of water are sufficient to remove soil thus loosened by heat and humidity.

According to embodiments of the present invention, problems of poor efficacy as well as excessive time and water consumption in automated systems for cleaning poultry chillers are solved by creating temperature and humidity conditions inside the soiled chiller that soften and release fat and other contaminants from interior surfaces in combination with washing the surfaces with sprays of water and/or cleaning solutions.

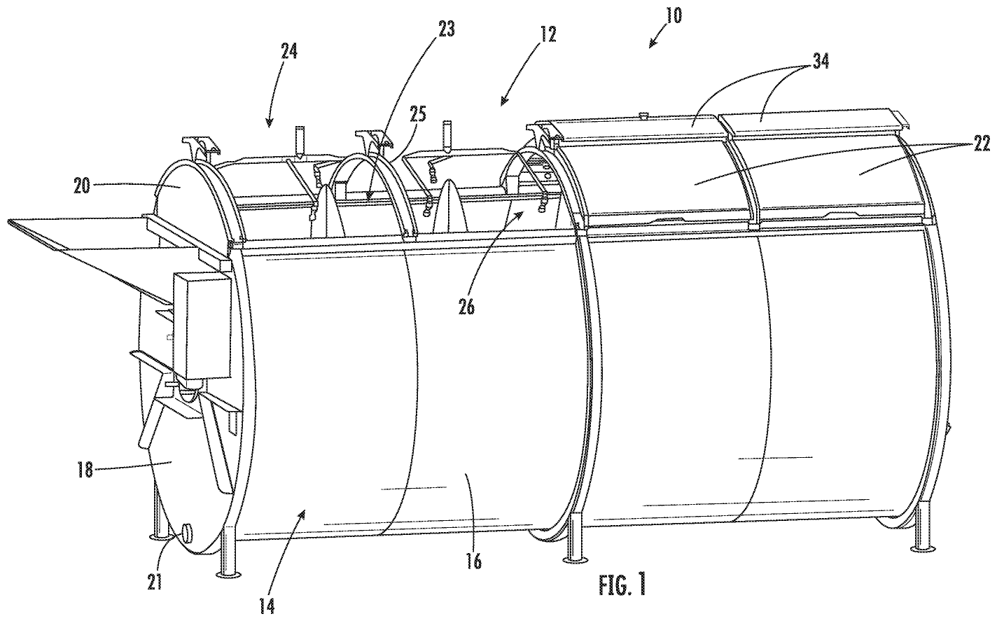

Referring to FIG. 1, an auger type chiller system 10 is shown including a chiller 12 comprising a tank 14 with side walls 16, an entrance end wall 18, an end wall partition 20 above the entrance end wall 18, and a drain fitting 21. The auger drive mechanism is not shown so that features relevant to the invention may be seen more clearly. The chiller is fitted with hoods 22 to at least partially cover an upper opening 23 that serve to keep foreign matter out of the chiller during operation as well as to contain warm moist air inside the chiller during cleaning. Some hoods on the left end of the chiller have been removed to reveal clusters 24 of spray nozzles 26 mounted beneath the hoods. The chiller might be longer or shorter than shown, and would have an exit end wall not shown in the figure.

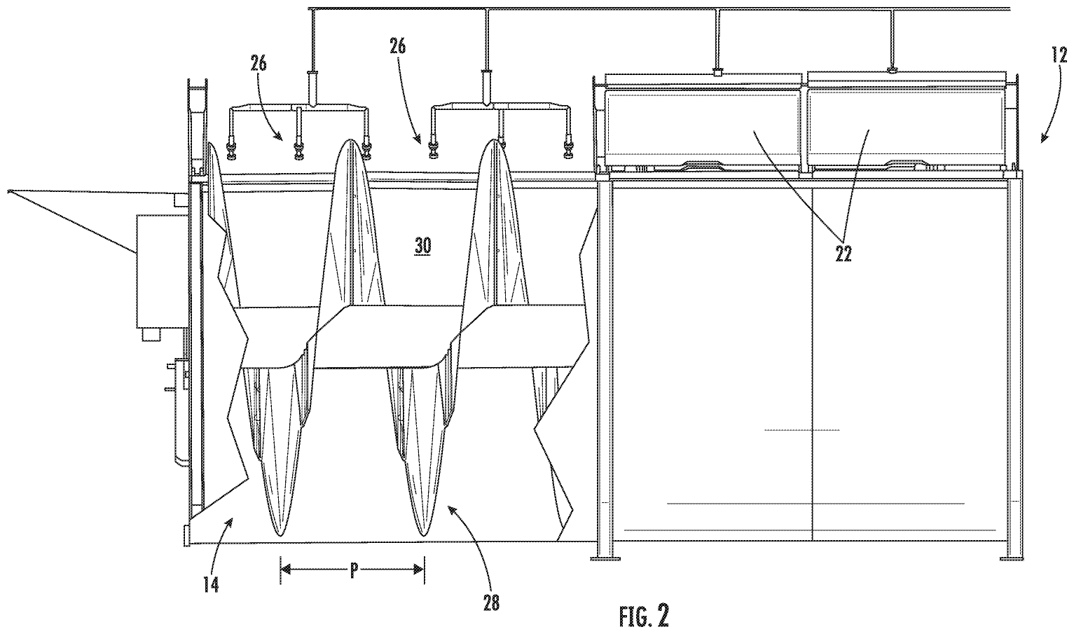

FIG. 2 shows the auger chiller 12 of FIG. 1 with some of the wall panels removed to reveal the interior of the tank 14 with interior surfaces, an auger 28, and interior volume 30. A plurality of spray nozzles 26 are mounted beneath the hoods 22. The nozzles 26 are connected to a system of piping that supplies water and/or cleaning agents to be dispersed within the interior volume 30.

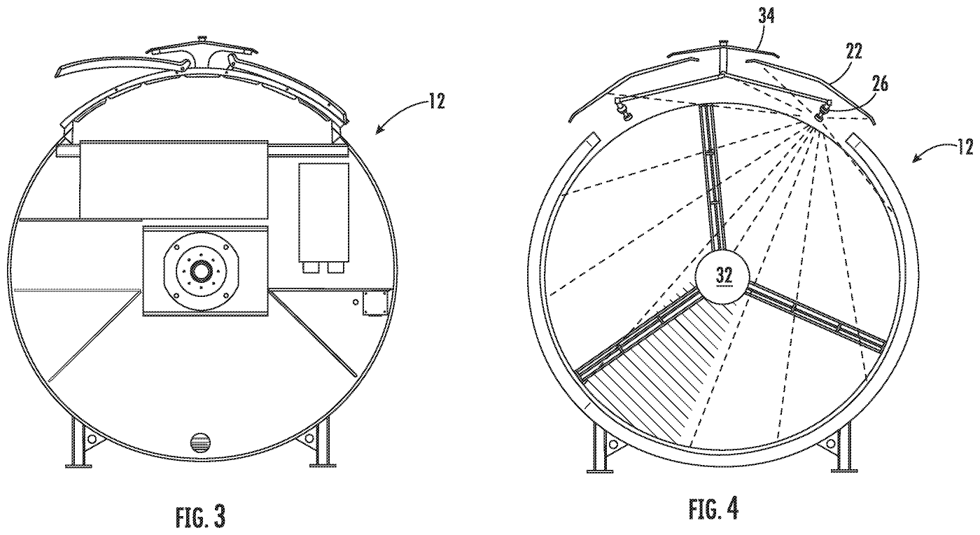

FIG. 3 shows an end view of the chiller 12.

FIG. 4 shows a cross section through the chiller 12. The nozzles 26 are located and directed in such a way that most if not all of the soiled surfaces will be impinged by the spray from at least one nozzle. In some embodiments, the nozzles 26 may have dispersion characteristics that provide nearly 360-degree coverage from the location of the nozzle 26.

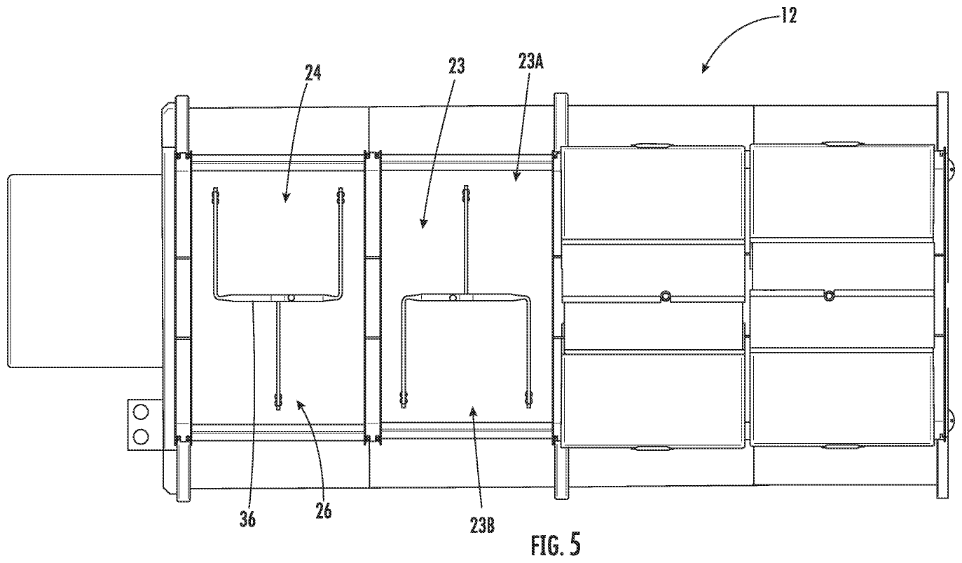

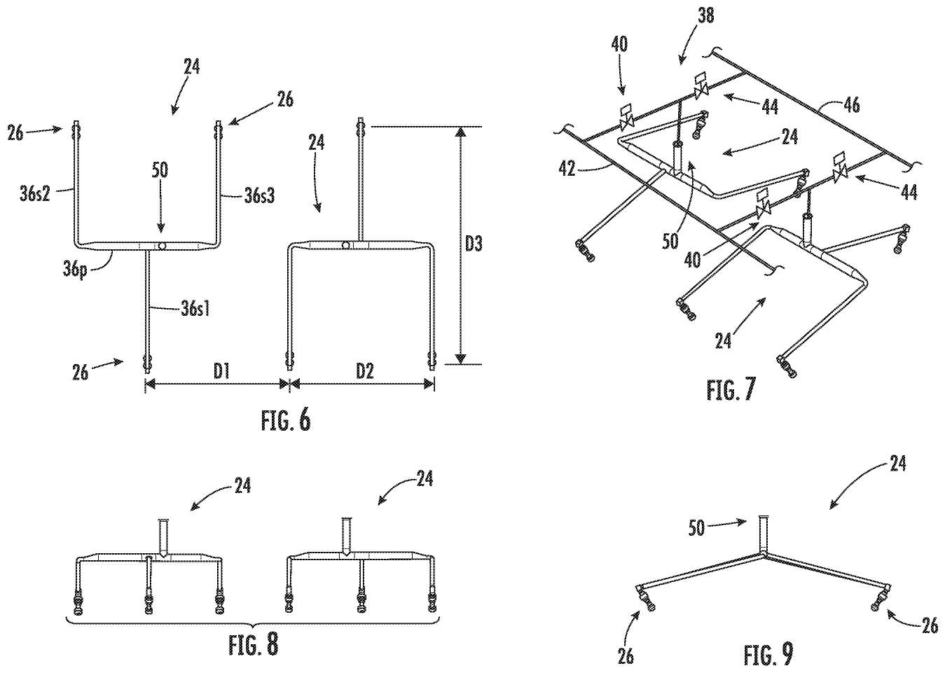

In the embodiment shown, the auger 28 may rotate to present various surfaces in turn to one or more nozzles. As illustrated in FIG. 6, spacing between adjacent nozzles 26, D1 and D2 as measured along the axial length of the chiller should be less than a pitch P of the auger 28 as shown in FIG. 2. This spacing will help assure full coverage of the interior surfaces including the auger surfaces by the sprays.

The nozzles may be mounted by extending structural members such as rods or beams from the tank and/or structural components of the enclosure system. Such structural members may attach to the nozzles or the piping system. In other embodiments, the nozzles and piping may be supported from outside the chiller. In some embodiments, nozzles may be attached to and/or penetrate the tank.

Interior components such as the auger may block sprays of liquid from reaching some interior surfaces. Movement of the interior components such as rotation of the auger can eliminate some of the spray shadows thus created. However, some of the internal components such as the auger shaft 32 will not move relative to the spray nozzles and thus the spray shadow is continuously present even as the auger rotates. See FIG. 4 (cross hatched portion illustrates a spray shadow). To provide coverage for such spray shadows, transverse spacing of the spray nozzles 26 should provide overlapping coverage from adjacent nozzles to assure that most of the interior surface is accessible by the spray from at least one nozzle. In order to provide overlapping coverage, transverse spacing D3 of FIG. 6 may be ⅓ to ⅔ the width of the chiller tank.

In embodiments addressing other types of chillers such as rocker chillers or drag chillers, different motive components such as dashers or paddles may move through their normal range of motion to intercept the spray of a nozzle. In such embodiments, spacing of the spray nozzles will be allocated in a manner that minimizes the amount of interior surface area that is permanently shadowed from the sprays.

In a preferred embodiment, the chiller is enclosed using hoods, covers, panels, curtains and/or other devices (generically referred to herein as hoods and/or covers) to retain warm moist air inside of the chiller. It is not necessary for such covers to completely seal the chiller, but merely to contain most of the heat and moisture within the tank. Tank walls, hoods, covers, panels and other enclosing features should cover at least 90% of a surface area bounding the interior volume of the chiller. In a preferred embodiment, the enclosing features should cover at least 95% of a surface area bounding the interior volume. The enclosure features may be configured to open to provide maintenance and inspection access to the tank as shown in FIG. 3. At the ends of the tank, panels 20 may be employed to bridge the space between the hoods and the end wall of the tank as shown in FIG. 1.

FIG. 5 shows a top view of the chiller of FIG. 1. Hoods 22 and covers 34 at the left end of the chiller have been removed to reveal clusters 24 of nozzles 26 and piping 36. For clarity, the auger is not shown.

Referring to FIG. 7, the piping system 38 may include valves 40 to control the distribution of liquids from a liquid header 42 supplying cleaning solution to clusters of one or more of spray nozzles. Separate control valves 44 control the distribution of water from a water header 46 to clusters of nozzles. In other embodiments, a single 3-way valve may control supply from a cleaning solution header and a water header to a cluster of nozzles. In yet other embodiments, cleaning solution and water may be delivered in turns through a single liquid header. Such valves may be operated in sequence such that liquid is supplied to a nozzle or group of nozzles for a period of time and then stopped. The valve configuration is then changed to supply liquid to a different nozzle or group of nozzles directed toward a different section of soiled surface. In some embodiments, the valves would be operated to sequentially direct liquid to groups of nozzles directed to adjacent sections of soiled surfaces such that the cleaning process advances along the length of the chiller.

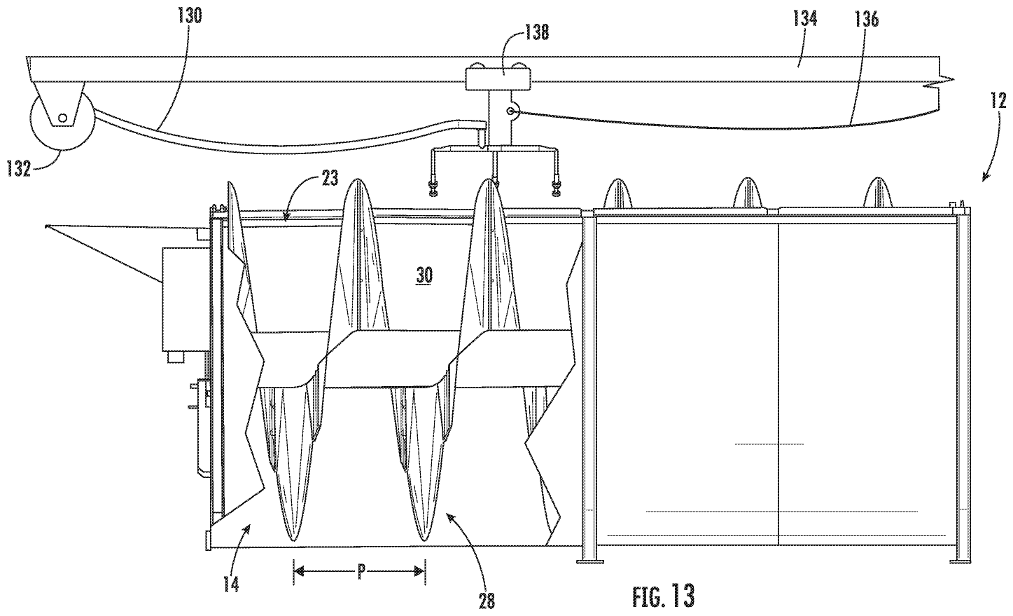

In other embodiments, as shown for example in FIG. 13, a single nozzle or nozzle cluster(s) may advance along the length of the chiller by physically moving the nozzles such as on a track that runs parallel to the length of the chiller. In such embodiments, multiple clusters of nozzles with separate control valves may not be required.

The number of nozzles included in a cluster of nozzles supplied through a single control valve will be determined by the flow characteristics of the nozzles and the flow of water and/or cleaning solution that can be supplied. For example, if the nozzle requires 15 gpm flow to provide acceptable dispersion and the cleaning liquid supply rate is 45 gpm, then there should be no more than 3 nozzles in a cluster. The size or flow rate of each nozzle should reflect the interior tank surface area to be covered by that nozzle. A flow of 1 gpm will service approximately 3-8 square feet of interior surface.

Referring to FIG. 6, in some embodiments, a respective nozzle cluster includes a primary pipe or hub or header 36p and first and second secondary pipes or extensions 36s1, 36s2. The first secondary pipe 36s1 may extend away from the primary pipe 36p in a first direction and the second secondary pipe 36s2 may extend away from the primary pipe 36p in a second, generally opposite direction. In some embodiments, additional secondary pipes (e.g., a third secondary pipe or extension 36s3) may extend away from the primary pipe 36p (e.g., in the second direction). It will be appreciated that a respective nozzle cluster may include a greater or lesser number of secondary pipes and corresponding nozzles. The primary pipe 36p includes an inlet 50 with the cleaning solution header 42 and the hot water header 46 in fluid communication with the inlet 50.

Referring to FIGS. 5 and 6, each nozzle cluster 24 may be positioned such that the first nozzle 26 connected to the first secondary pipe 36s1 is adjacent one of a first side 23A and an opposite second side 23B of the upper opening 23 and the second nozzle 26 connected to the second secondary pipe 36s2 and optionally the third nozzle 26 connected to the third secondary pipe 36s3 is adjacent the other one of the first side 23A and the second side 23B of the upper opening 23.

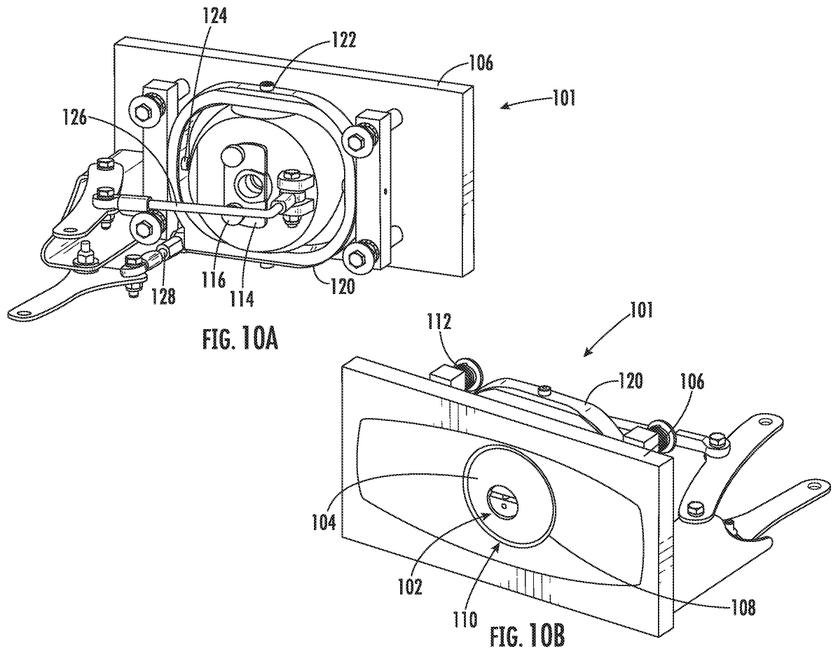

Referring to FIG. 9, in a preferred embodiment, the piping system will be configured to provide a continuous down grade from the inlet 50 to each nozzle. Such a configuration allows liquid in the piping system to drain out through the nozzle without trapping liquid in the piping.

Cleaning solution or water sprayed onto the interior surfaces of the chiller will flow down the surface and collect in the bottom of the tank. From there, the liquid will flow out of the tank through a drain fitting 21 (FIG. 1). The liquid may be discharged to a waste water system or collected, filtered or otherwise cleaned and reused depending on the preferences of the operator.

The cleaning process progresses through a series of sequential steps. The first step is to close the hoods or covers or other features in order to contain heat and humidity within the interior volume. Then heat and humidity is added to the interior volume. In some embodiments, this may be accomplished by spraying hot water through the nozzles and onto the interior surfaces of the chiller. Water in the range of 90° F. to 160° F. can be effective. Water in the range of 120° F. to 150° F. may be preferred. In alternative embodiments, low-pressure steam may be injected into the interior volume to increase the temperature and humidity of the air inside the chiller. In yet other embodiments, heat may be applied to the outer surface of the tank wall. The air temperature in the enclosed volume should exceed 90° F. and the humidity ratio should exceed 0.028 pounds moisture per pound of dry air. Preferably, air temperature should exceed 110° F. and the humidity ratio should exceed 0.034 pounds moisture per pound of dry air.

Conditions of warm air and high humidity should be maintained inside the chiller for a period of time that allows fat that may be soiling the interior surfaces to soften or melt and begin to flow toward the bottom of the chiller. In some situations, 2 minutes may be an adequate duration. In cases of heavy soil and/or low ambient temperature, soak times of 5 minutes or more may be preferred. It may not be necessary to spray water over the interior surfaces for the full duration of the soak time provided that temperature and humidity are maintained. It is preferred that the duration of the spray application exceed the time for one complete cycle of the internal mechanism. For example, in an auger chiller, the duration of the spray application should be long enough to allow a complete revolution of the auger.

Following treatment with heat and humidity, a cleaning solution is applied to the interior surfaces of the chiller. This is achieved by dispersing the cleaning solution through nozzles which may be the same nozzles used for water or could be different nozzles dedicated to cleaning solution. The cleaning solution may be one of several commercially available types currently used in the poultry industry. Foaming solutions may be preferred as they may remain on the surfaces longer before draining off. The cleaning solution should be left in place for an amount of time recommended by the manufacturer to dissolve and disperse soil on the interior surfaces. The chiller should remain fully enclosed to retain as much heat and humidity as possible.

The final step is to rinse any remaining soil and cleaning solution off the interior surfaces. This is accomplished by spraying hot water through the nozzles onto the interior surfaces. This water rinses soil and cleaning solution into the bottom of the chiller tank and out through the drain. This step should continue until the drain runs clear.

As described earlier, this process may be applied in sequence along the length of the chiller. The first process step may be applied through the first nozzle cluster at one end of the chiller, and subsequently through the adjacent second cluster of nozzles and so on down the length of the chiller. Progression from one cluster to an adjacent cluster is not a necessary aspect of the process, but is suggested here merely as a convenience. Progression from one cluster to another may proceed in any sequence desired.

Application of the cleaning solution may proceed once the appropriate heat-and-humidity soak time is completed in a particular area of the chiller. For example, hot water may be applied to a first end of the chiller through a first cluster of nozzles, and subsequently through a second cluster of nozzles and so on down the length of the chiller. Once the desired soak time has elapsed at the first end of the chiller, application of the cleaning solution may begin at that end even if the heat-and-humidity treatment is still in progress further down the chiller. Of course, care should be exercised to prevent water spray in another part of the chiller from unintentionally rinsing off the cleaning solution prematurely.

Likewise, the final rinse step can begin at the first end of the chiller once the cleaning solution set time has elapsed in that location, even if cleaning solution is still being applied in other parts of the chiller.

In another embodiment, the nozzles through which water and/or cleaning solution are applied to the interior surfaces of the tank may produce focused jets of fluid as opposed to broadly dispersed sprays and may further be articulated in a manner that allows the jets to be directed at various tank surfaces in sequence.

In addition to heat and humidity, the jets of fluid provide high impact and momentum to remove soil from the tank surfaces. Jet velocities at the nozzle of 40 to 100 feet per second have been shown to be effective with velocities of 65 to 75 feet per second being preferred. Jet flows of 3 to 20 gallons per minute have been shown to be effective with flows of 4 to 10 gallons per minute being preferred.

In selecting appropriate flow rates and velocity, reduced flow can be offset by increased velocity and vice versa. The product of mass flow rate (m′) times velocity squared (v²) yields a power (P) term that guides this trade-off as shown in the following equation:

P=½m′v²

Flow power of 150 to 1500 pounds-feet per second have been shown to be effective with power of 270 to 900 pounds-feet per second being preferred.

Additional consideration may be given to the way fluid momentum is distributed over a surface area impacted by the jet. Those skilled in the art will appreciate that this area may depend upon the distance from the nozzle to the surface, the divergence angle of the jet and the type of spray pattern such as solid jet, hollow cone or flat fan. Average momentum (M) is defined as mass flow rate (m′) times average velocity over the impact area. Average velocity at impact may be determined as volume flow rate (V′) divided by impact area (A). Combining these concepts yields an equation:

M=m′V′/A

Average momentum of 0.013 to 0.075 pounds force has been shown to be effective with momentum above 0.036 pounds force being preferred.

The jet sprays may be of various patterns to achieve different results. Narrow jet sprays of conical shape with spray angle up to 5 degrees have been shown to be effective for maintaining spray impact at distances as much as 12 feet from the sprayed surface. Fan sprays of an elliptic cone shape with nominally narrow minor axis angle have been effective for spraying a larger surface while maintaining sufficient impact at medium distances. Fan sprays with minor axis angles up to 5 degrees have been shown to be effective with major axis angles of 30 to 90 degrees with major axis angles of 50 to 90 degrees providing a good trade-off between surface coverage and spray impact.

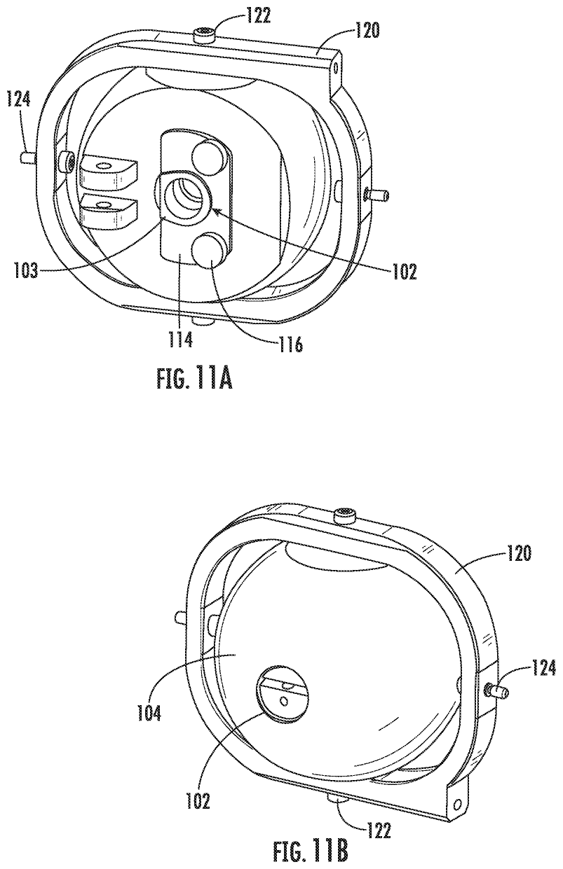

A gimballed mount for the jet nozzle allows the jet to be aimed at various surfaces within the tank. Referring to FIGS. 10 and 11, a gimbal nozzle assembly or gimballing system 101 may comprise a ball-and-socket configuration in which the nozzle 102 is mounted in a spherical or partially spherical nozzle mount 104—the ball—that fits against a socket 106 comprising a rim 108 that substantially seals against the spherical portion of the nozzle mount 104 and an opening 110 through which the nozzle 102 is afforded a view the interior 30 of the tank 14 (FIG. 2). The ball mount 104 may be substantially spherical or only the portion of the mount adjacent the socket rim 108 may be spherical. Biasing members such as springs 112 are provided to maintain firm contact between the spherical portion of the nozzle mount 104 and the socket 106.

The jet nozzle 102 may be attached to the nozzle mount 104 by threaded engagement, clamps, retaining plate or other well-known attachment mechanisms. FIGS. 10A and 11A illustrate the use of a retaining plate 114 and fasteners 116. In alternate embodiments, the ball mount itself may incorporate internal passages defining the nozzle.

A fluid supply member such as a hose (not shown) may be connected to a fitting 103 on the inlet end of the nozzle 102 to supply fluid to the nozzle 102. The fluid supply member must accommodate the range of motion of the nozzle in operation.

Further features are attached to the ball mount 104 to cause it to rotate about its spherical center relative to the socket 106. Such features may comprise a yoke 120 attached to the nozzle mount 104 by an axle 122 that allows the nozzle mount to rotate about the axis of the axle 122. In turn, the yoke may be attached to the socket or socket assembly 106 by a second axle 124 oriented at an angle to the first axle 122. The yoke 120 together with the ball mount 104 may be rotated about the second axle 124 relative to the socket 106. In a preferred embodiment, the two axles are perpendicular to each other.

In other embodiments, the gimballing system may comprise a backing plate having a rim similar to that of the socket which engages spherical portions of the nozzle mount. The backing plate is attached to the socket in such a way that the nozzle mount is captured between them while still being able to rotate about its spherical center relative to the socket.

The nozzle 102 directs a jet of fluid through the opening 110 in the socket 106 toward the interior surfaces of the tank. The ball 104 may be swiveled within the socket 106 through a range of 30 degrees horizontally and vertically up to a range of 45 degrees. Preferably, the nozzle 102 is oriented to direct a stream of fluid through the socket opening 110 throughout this range of motion, however, in some embodiments, the nozzle 102 may be obstructed by portions of the socket 106 in certain parts of its range of motion.

In some embodiments, the ball 104 may intentionally be swiveled fax enough in its range of motion that the tip of the nozzle 102 is no longer directed through the opening 110 in the socket 106. When the cleaning system is not in use, the nozzle 102 may be stowed in such a position to preclude the possibility of cleaning solution leaking into the tank during processing operation.

The nozzle 102 may be articulated using linkages 126, 128 connected to the nozzle 102 or nozzle housing 104 such that pushing the end of the linkage 126 or 128 in a substantially linear motion by means of a linear actuator causes the nozzle 102 to pivot about an axis. Separate linkages may be provided to pivot the nozzle about different axes such as x and y axes. Linear actuators might include 3-bar or 4-bar linkages, hydraulic cylinders, jack screws or other such well-known mechanisms.

In other embodiments, the nozzle may be articulated using rotary actuators that rotate the nozzle mount relative to the yoke and rotate the yoke relative to the socket. Rotary actuators might include stepper motors, hydraulic actuators or gears engaging spurs on the housing or other such well-known mechanisms.

Referring to FIGS. 1, 10A, and 10B, the nozzle assembly 101 may be mounted in the tank wall 16 such that the socket 106 is flush or substantially flush with the inner face of tank wall 16. Alternatively, the nozzle assembly 101 may be mounted above the upper opening 23 on a mounting structure or surface such as the arch 25 that supports the covers 34 or at the top of the tank wall 16.

As previously described with reference to FIG. 6, axial spacing between adjacent nozzle assemblies 101 should be less than a pitch P of the auger 28 as shown in FIG. 2.

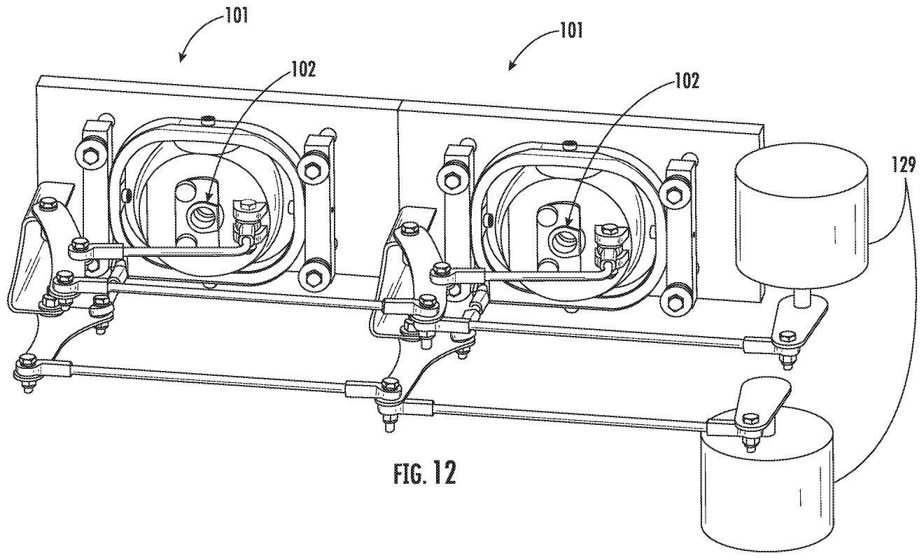

Referring to FIG. 12, in some embodiments, two or more nozzles 102 may be linked together such that one set of actuators 129 causes the linked nozzles to move in tandem as they direct jets of fluid against multiple interior surfaces.

In other embodiments, the nozzle may be mounted in a gimbal system similar to that described previously but without the ball and socket. In such embodiments, the nozzle mount need not have any spherical portion. Rather than being positioned adjacent a socket, the nozzle mount and/or yoke of this embodiment is attached to any convenient fixed structure affording a view of interior surfaces of the tank. The nozzle and mounting assembly must not interfere with the operation of the tank or with the motion of any components inside the tank. In operation, actuators would cause the nozzle to pivot about one or more axes directing jets of fluid to sweep across the interior surfaces of the tank.

Referring to FIG. 13, in other embodiments, a single nozzle or a single cluster of nozzles 24 travels along the length of the tank 14 above the upper opening 23 but beneath any hoods or covers (the hoods or covers are the same or similar to those shown in FIGS. 1 and 2 but not shown in FIG. 13 to more clearly illustrate the traveling system). Whereas previously described embodiments used multiple clusters of nozzles in fixed locations to provide spray coverage for substantially all of the interior surfaces, this embodiment uses a single nozzle or cluster of nozzles 24 which move to different stations in the tank 14 to provide coverage. In some embodiments, the nozzle or cluster of nozzles 24 may spray fluid continuously as it travels along the tank 14. This embodiment employs methods similar to those previously described for spraying water into a substantially enclosed portion of the tank to increase the heat and humidity followed by application of a cleaning agent to the interior tank surfaces and a final rinse.

The piping supplying fluid to the traveling nozzles 24 must have sufficient flexibility to accommodate the range of motion of the nozzles 24 within or above the tank. For example, fluid could be supplied through a hose 130 wound around a reel 132. As the nozzles 24 move along the tank 14 away from the reel 132, the reel 132 rotates to unspool an additional length of hose 130 to reach the nozzles 24. In other embodiments, a hose may be suspended at intervals from an overhead rail. The support points can travel down the rail as needed to reach the traveling nozzles while the hose simply drapes between support points where any slack exists.

The traveling nozzles 24 may be supported and guided by a rail 134 mounted above the upper opening 23 of the tank 14. In some embodiments, power to move the nozzles 24 may be supplied from external sources such as a draw cable 136 attached to the nozzle carriage 138. The cable 136 may be pulled by a winch. In other embodiments, pressure and flow of the fluid will be harnessed to provide the motive force to advance the nozzles along the length of the chiller. In yet other embodiments, the rotation of the auger 28 in the tank 14 may propel the nozzle cluster along the tank. Persons skilled in the art will appreciate that many other means are available to drive the traveling nozzle or nozzle cluster.

It will be appreciated that the intent of the invention is to provide an automated process for removing most but not necessarily all of the soil from a poultry chiller. It may be necessary to manually spot clean certain locations or particularly heavy build-ups of soil following completion of the automated process.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1. A method for automated cleaning of an immersion tank, the method comprising:
substantially enclosing an interior volume of the immersion tank;
increasing the temperature and humidity in the interior volume of the immersion tank; then
applying cleaning solution to interior surfaces of the immersion tank; and
rinsing the cleaning solution and soil off the interior surfaces of the immersion tank.

2. The method of claim 1 wherein substantially enclosing an interior volume of the immersion tank comprises closing hoods and/or covers over an upper opening of the immersion tank.

3. The method of claim 1 wherein increasing the temperature and humidity in the interior volume of the immersion tank comprises spraying hot water through nozzles into the interior volume of the immersion tank.

4. The method of claim 3 wherein applying cleaning solution to interior surfaces of the immersion tank comprises dispersing the cleaning solution through the nozzles onto the interior surfaces of the immersion tank.

5. The method of claim 4 wherein the nozzles are arranged such that cleaning solution is applied to substantially all of the interior surfaces of the immersion tank.

6. The method of claim 4 wherein rinsing the cleaning solution and soil off the interior surfaces of the immersion tank comprises spraying water through the nozzles onto the interior surfaces of the immersion tank.

7. The method of claim 6 wherein:
the immersion tank comprises an auger oriented in a longitudinal direction in the interior volume of the immersion tank; and
adjacent ones of the nozzles are spaced apart in the longitudinal direction a lesser distance than a pitch of the auger.

8. The method of claim 1 wherein the temperature and humidity are increased in each portion of the interior volume of the immersion tank for at least two minutes before the cleaning solution is applied to interior surfaces of the immersion tank.

9. The method of claim 1 further comprising draining the cleaning solution and soil from the interior volume of the immersion tank.

10. The method of claim 1 further comprising translating at least one nozzle axially along the tank, wherein the increasing, applying, and/or rinsing steps are carried out using the at least one nozzle sequentially at different axial locations along the tank.

11. The method of claim 1 wherein the immersion tank is a poultry chiller.

12. A system for automated cleaning of an immersion tank, the system comprising:
an immersion tank comprising a tank defining an interior volume and an upper opening in communication with the interior volume;
one or more hoods and/or covers configured to selectively cover the upper opening to substantially enclose the interior volume; and
at least one nozzle configured to:
spray hot water into the interior volume to increase the temperature and humidity in the interior volume;
disperse cleaning solution onto interior surfaces of the immersion tank; and
spray water onto the interior surfaces of the immersion tank to remove the cleaning solution and soil therefrom.

13. The system of claim 12 wherein the at least one nozzle comprises a plurality of nozzle clusters distributed axially along the tank, each nozzle cluster comprising a plurality of nozzles.

14. The system of claim 13 wherein each nozzle cluster comprises:
a primary pipe with an inlet;
a first secondary pipe extending laterally away from a first side of the primary pipe;
a second secondary pipe extending laterally away from a second, opposite side of the primary pipe;
a first nozzle at the end of the first secondary pipe and a second nozzle at the end of the second secondary pipe,
wherein the nozzle cluster is positioned such that the first nozzle is adjacent a first side of the upper opening and the second nozzle is adjacent a second, opposite side of the upper opening.

15. The system of claim 14 wherein the first and second nozzles each comprise dispersion characteristics that provide substantially 360-degree coverage from the location of the nozzle.

16. The system of claim 14 wherein each nozzle cluster comprises:
a third secondary pipe extending laterally away from the second side of the primary pipe and spaced apart from the second secondary pipe;
a third nozzle at the end of the third secondary pipe,
wherein a first nozzle cluster is positioned such that the first nozzle is adjacent the first side of the upper opening and the second and third nozzles are adjacent the second side of the upper opening and a second nozzle cluster adjacent the first nozzle cluster is positioned such that the first nozzle is adjacent the second side of the upper opening and the second and third nozzles are adjacent the first side of the upper opening.

17. The system of claim 14 wherein the first and second secondary pipes each extend outwardly and downwardly from the primary pipe such that substantially all liquid in the pipes drain out through the nozzles when the supply of liquid is stopped.

18. The system of claim 14 further comprising:
a hot water header in fluid communication with the inlet of the primary pipe;
a first control valve between the hot water header and the inlet of the primary pipe to selectively supply hot water to the nozzle cluster;
a cleaning solution header in fluid communication with the inlet of the primary pipe; and
a second control valve between the cleaning solution header and the inlet of the primary pipe to selectively supply cleaning solution to the nozzle cluster.

19. The system of claim 12 further comprising a rail below the one or more hoods and/or covers and a carriage connected to the rail with the at least one nozzle connected to the carriage, wherein the carriage and the nozzle are configured to travel on the rail axially along the tank to sequentially spray hot water and cleaning solution at different axial locations along the tank.

20. The system of claim 12 wherein the at least one nozzle is held within an at least partially spherical nozzle mount that is held in a socket, and wherein the nozzle mount is rotatable and/or translatable in the socket such that the nozzle is articulated to sequentially direct the hot water and/or cleaning solution to different interior surfaces in the interior volume of the tank.

21. The system of claim 12 wherein the immersion tank is a poultry chiller.

22. The method of claim 1 wherein increasing the temperature and humidity in the interior volume of the immersion tank comprises injecting steam into the interior volume of the immersion tank.

23. The method of claim 1 wherein increasing the temperature and humidity in the interior volume of the immersion tank comprises applying heat to a wall of the tank.
